(19) United States
(12) Patent Application Publication
(10) Pub. No.: US 2009/0194030 A1
(43) Pub. Date: Aug. 6, 2009

(54) Feeding mouthpiece

(76) Inventor: Hsiao-Chen Liang, Hua Tan Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/012,953

(22) Filed: Feb. 6, 2008

(51) Int. Cl. A01K 9/00

(52) U.S. Cl. 119/71

(57) ABSTRACT

A feeding mouthpiece has a body and a tube. The body is hollow, a resilient material and has two ends, a teat and a seal. The teat is formed on one end of the body, has an opening and corresponds to a mouth of young. The seal is formed on the other end of the body and has a sealing surface. The tube is formed through and protrudes from the sealing surface of the seal, is tapered to a transverse ridge and has an outer surface, a proximal end, two gables and an air valve. The air valve is a slit and may be formed along the transverse ridge or longitudinally on the outer surface of the tube. When the feeding mouthpiece is mounted with a bottle, the air valve prevents leakage and is easily cleaned without tearing or breaking the feeding mouthpiece.

### BACKGROUND OF THE INVENTION

1. Field of the Invention

The present invention relates to a feeding mouthpiece, especially relates to a feeding mouthpiece having an air valve to prevent leakage.

2. Description of the Related Art

With reference to FIG. 9, a feeding mouthpiece is used to nurse babies, young children and animals. The conventional feeding mouthpiece (20) is a resilient material such as rubber, silicon, plastic or the like and has a body (21) and an air tube (22) The body (21) has two ends, a teat (212) and a seal (213). The teat (212) is formed at the one end of the body (21) and is corresponds to a mouth of an infant or young child. The seal (213) is formed on and protrudes from the other end of the body (21) and has a sealing surface.

The air tube (22) is formed on the sealing surface of the seal (213) and has a cross air valve (221) formed therethrough. The cross air valve (221) comprises four tabs each separated by a slit. The feeding mouthpiece (20) is usually mounted on a bottle and air passes through the cross air valve (221) when the feeding mouthpiece (20) is sucked by the baby to allow liquid to come out without compressing the bottle. The air tube (22), therefore, allows a tight seal to be formed between the bottle and the feeding mouthpiece (20) yet allows easy use of the feeding mouthpiece (20).

However, the cross-opened air valve (221) is hard to clean and is easily torn during cleaning since each tab is independent of the others and the slit is not reinforced. Once one tab is torn the air valve (221) allows air to flow freely and leakage through the teat (111) and air valve (221) occurs, requiring feeding mouthpiece (20) replacement. Therefore, an improved feeding mouthpiece that can prevents leakage and is easy to clean without damaging the feeding mouthpiece is necessary in the related field.

### SUMMARY OF THE INVENTION

The main objective of the present invention is to provide a feeding mouthpiece having an air valve to prevent leakage and tearing.

To achieve the foregoing objective, the feeding mouthpiece in accordance with the present invention comprises a body and a tube. The body is hollow, a resilient material and has two ends, a teat and a seal. The teat is formed on one end of the body, has an opening and corresponds to a mouth of young. The seal is formed on the other end of the body and has a sealing surface. The tube is formed through and protrudes from the sealing surface of the seal, is tapered to a transverse ridge and has an outer surface, a proximal end, two gables and an air valve. The air valve is a slit and may be formed along the ridge or longitudinally on the outer surface of the tube. When the feeding mouthpiece is mounted with a bottle, the air valve prevents leakage and is easily cleaned without tearing or breaking the feeding mouthpiece.

Other objectives, advantages and novel features of the invention will become more apparent from the following detailed description when taken in conjunction with the accompanying drawings.

### BRIEF DESCRIPTION OF THE DRAWINGS

FIG. 1 is a perspective front view of a feeding mouthpiece in accordance with the present invention;

FIG. 2 is a cross sectional view of the feeding mouthpiece in FIG. 1;

FIG. 3 is a perspective view in partial section of the feeding mouthpiece in FIG. 1;

FIG. 4 is a side view of the feeding mouthpiece in FIG. 1;

FIG. 5 is a perspective view of a second variant of a tube for a feeding mouthpiece in accordance with the present invention;

FIG. 6A is an enlarged cross sectional view of the tube in FIG. 1;

FIG. 6B is an enlarged cross sectional view of a third variant of a tube for a feeding mouthpiece in accordance with the present invention;

FIG. 6C is an enlarged cross sectional view of a fourth variant of a tube for a feeding mouthpiece in accordance with the present invention;

FIG. 6D is an enlarged cross sectional view of a fifth variant of a tube for a feeding mouthpiece in accordance with the present invention;

FIG. 7 is a perspective view of a sixth variant of a tube for a feeding mouthpiece in accordance with the present invention;

FIG. 8A is an enlarged cross sectional view of the tube in FIG. 7;

FIG. 8B is an enlarged cross sectional view of a seventh variant of a tube for a feeding mouthpiece in accordance with the present invention;

FIG. 8C is an enlarged cross sectional view of a eighth variant of a tube for a feeding mouthpiece in accordance with the present invention; and

FIG. 9 is a perspective view of a conventional feeding mouthpiece in accordance with the prior art.

### DETAILED DESCRIPTION OF THE PREFERRED EMBODIMENTS

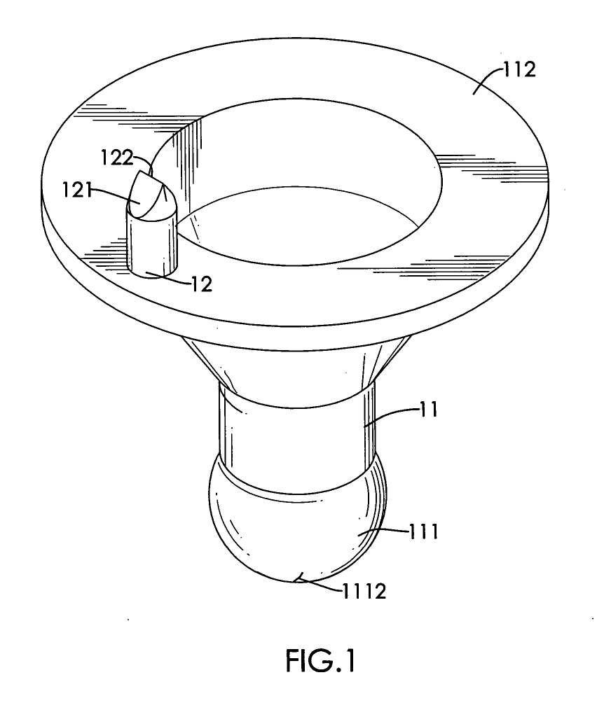

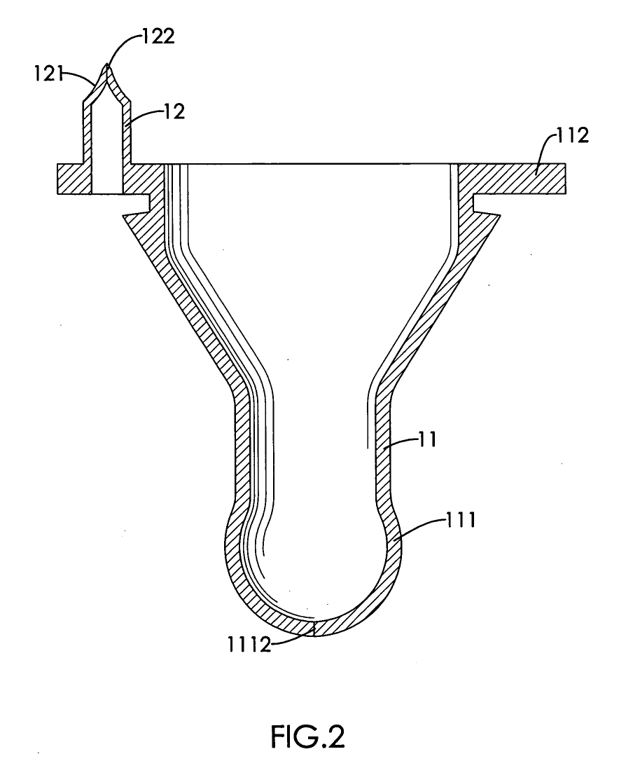

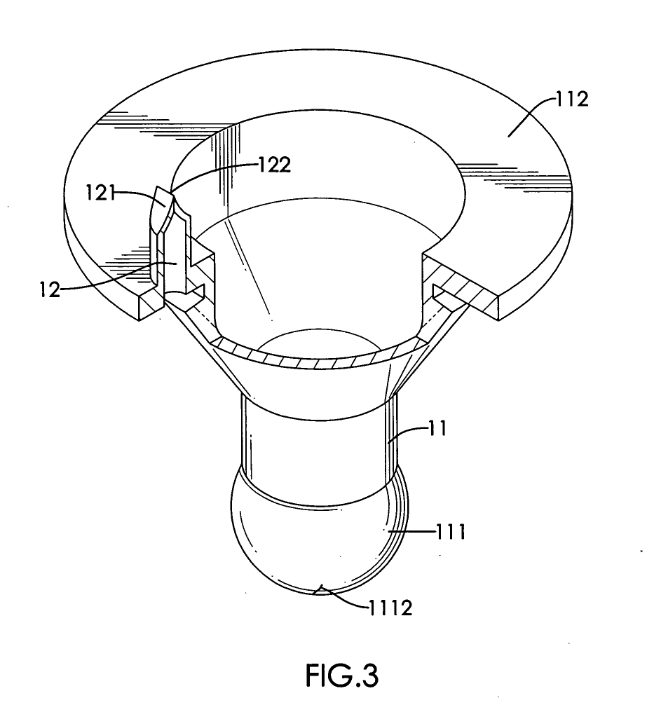

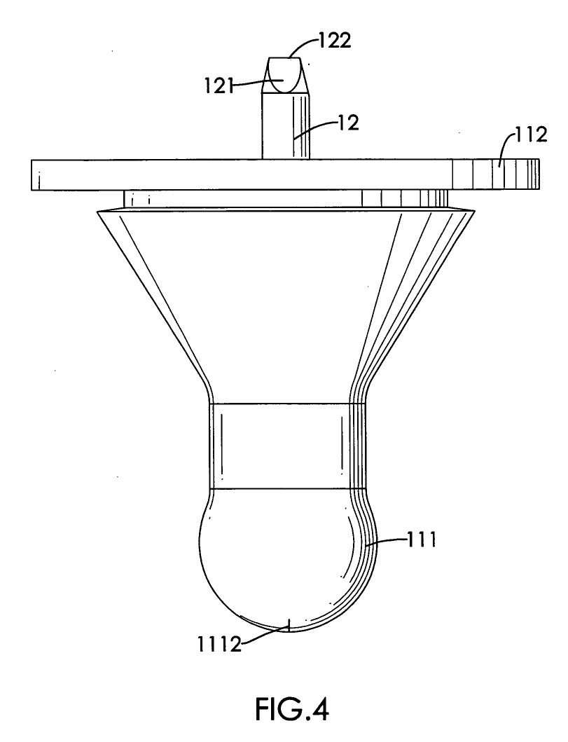

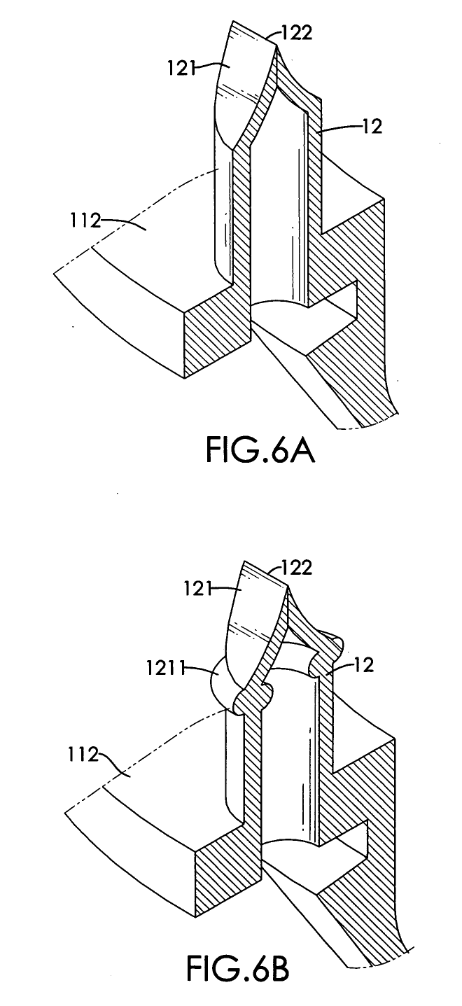

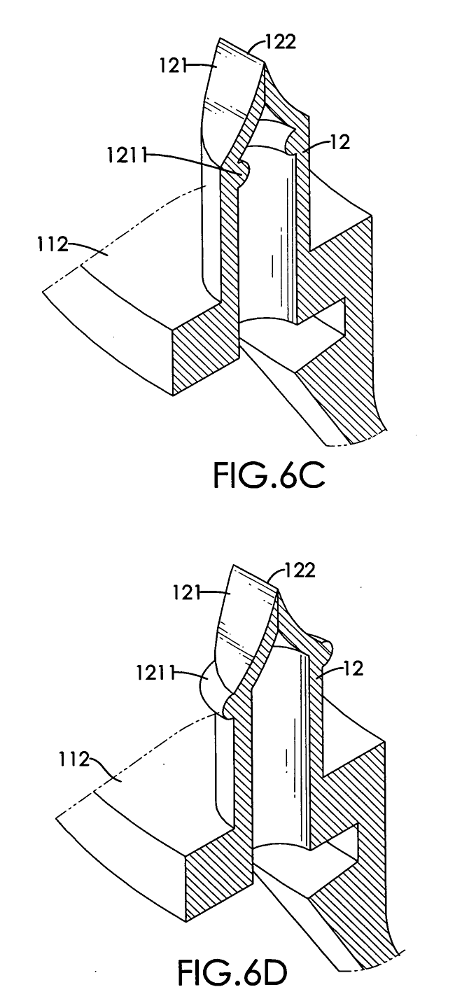

With reference to FIGS. 1 to 4 and 6A, a feeding mouthpiece in accordance with the present invention has a body (11) and a tube (12).

The body (11) is hollow, is a resilient material, such as rubber, plastic, silicone or the like and has two ends, a teat (111) and a seal (112). The teat (111) of the body (11) is formed on one end of the body (11) and has an opening (1112). The teat (111) corresponds to a mouth of an infant or young child. The seal (112) is formed on the other end of the body (11) and has a sealing surface. The seal (112) is mounted to ensure liquid does not leak during bottle inversion and usage.

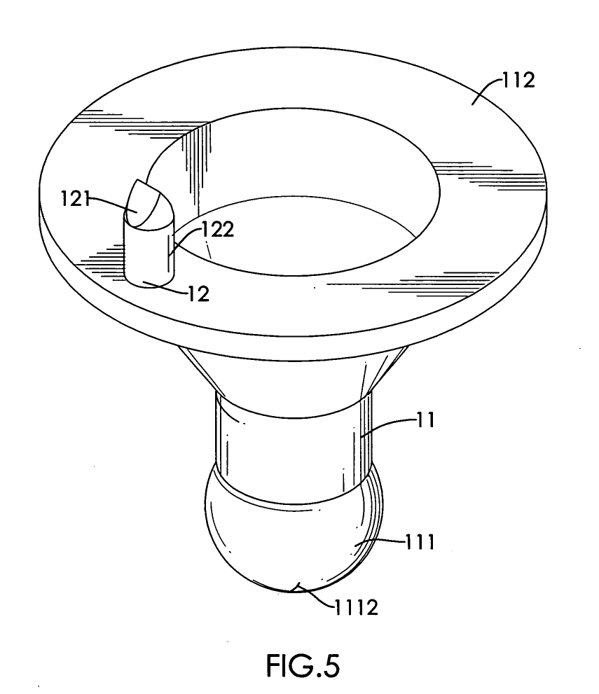

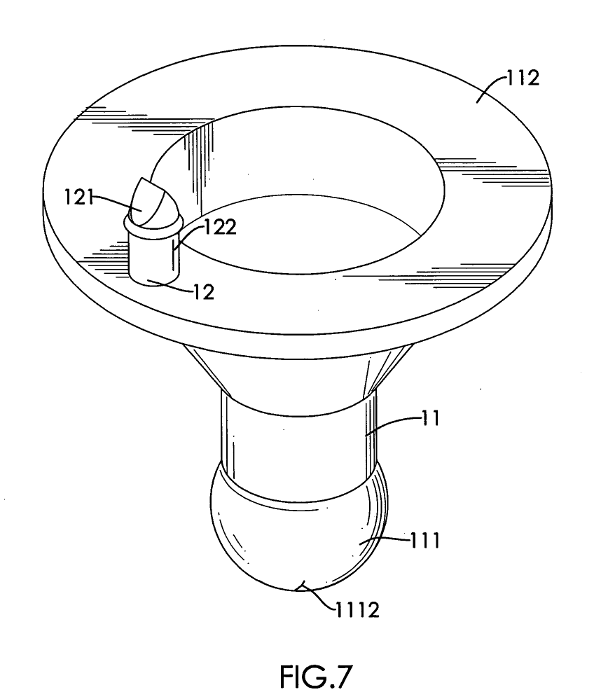

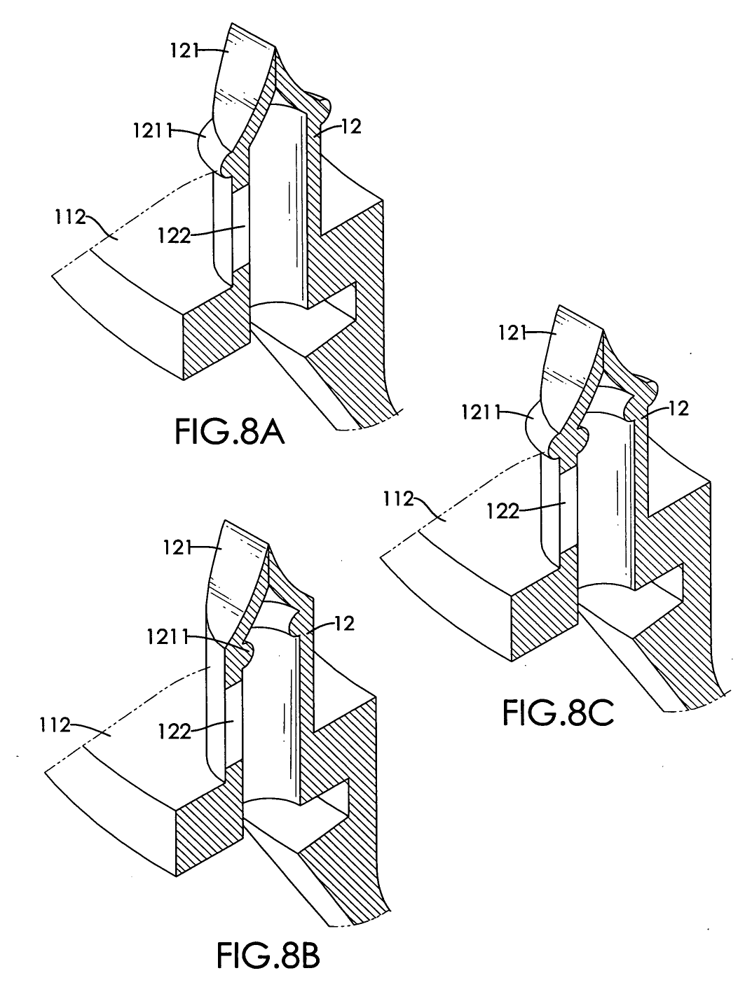

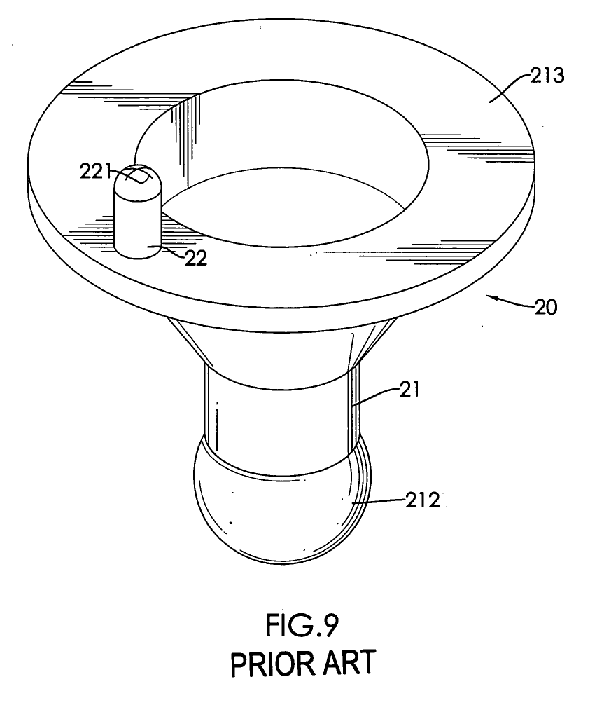

With further reference to FIGS. 5, 6B, 6C, 6D, 7, 8A, 8B and 8C, the tube (12) is formed through and protrudes from the sealing surface of the seal (112) is tapered to a transverse ridge and has an outer surface, an inner surface, a proximal end, two gables (121), an air valve (122) and an optional collar (1211). The gables (121) are formed at the proximal end of the tube (12).

The air valve (122) may be a slit that is formed in the proximal end of the tube (12) and communicated with an inside space of the tube (12), may be formed along the transverse ridge of the tube (12), or may be formed longitudinally in the outer surface of the tube (12) and communicated with an inside space of the tube (12).

The optional collar (1211) is mounted adjacent to the proximal end of the tube (12) and below the gables (121) to enhance structure strength of the tube (12) and prevent from ripping off while cleaning. The collar (1211) may also be mounted both on the inner and the outer surface of the tube (12). The collar (1211) may be formed on either the outer surface or the inner surface of the tube (12).

The feeding mouthpiece of the present invention may be used as a pacifier, or mounted on a bottle for nursing young. When the feeding mouthpiece is mounted on a bottle, the air valve (122) only opens when pressure inside the bottle drops due to sucking, therefore prevents leakage when not in use. Moreover, the tapering of the tube (12) can be cleaned easily and is not easily tom or broken while cleaning.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A feeding mouthpiece, comprising:
a body being hollow, a resilient material and having two ends;
a teat being formed on one end of the body and having an opening; and
a seal being formed on an other end of the body and having a sealing surface; and
a tube being formed through and protruding from the sealing surface of the seal, being tapered to form a transverse ridge and having
an inside space;
an outer surface;
an inner surface;
a proximal end;
two gables being formed on the proximal end; and
an air valve being formed in the tube and communicated with the inside space.

2. The feeding mouthpiece as claimed in claim 1, wherein the air valve is formed along the transverse ridge of the tube.

3. The feeding mouthpiece as claimed in claim 1, wherein the air valve is formed longitudinally in the outer surface of the tube.

4. The feeding mouthpiece as claimed in claim 2, wherein the tube further comprises a collar being adjacent to the proximal end of the tube below the gables.

5. The feeding mouthpiece as claimed in claim 3, wherein the tube further comprises a collar being adjacent to the proximal end of the tube below the gables.

6. The feeding mouthpiece as claimed in claim 4, wherein the collar being formed on the outer surface of the tube.

7. The feeding mouthpiece as claimed in claim 5, wherein the collar being formed on the outer surface of the tube.

8. The feeding mouthpiece as claimed in claim 4, wherein the collar being formed on the inner surface of the tube.

9. The feeding mouthpiece as claimed in claim 5, wherein the collar being formed on the inner surface of the tube.

10. The feeding mouthpiece as claimed in claim 4, wherein the collar being formed on the outer and inner surfaces of the tube.

11. The feeding mouthpiece as claimed in claim 5, wherein collar being formed on the outer and inner surfaces of the tube.
